(19) United States
(12) Patent Application Publication
(10) Pub. No.: US 2017/0094097 A1
(43) Pub. Date: Mar. 30, 2017

(54) IMAGE FORMATION APPARATUS, IMAGE FORMATION METHOD, AND NON-TRANSITORY COMPUTER READABLE RECORDING MEDIUM THAT STORES IMAGE FORMATION PROGRAM

(71) Applicant: Konica Minolta, Inc., Tokyo (JP)

(72) Inventor: Ken Miyazaki, Sagamihara (JP)

(73) Assignee: Konica Minolta, Inc., Tokyo (JP)

(21) Appl. No.: 15/250,093

(22) Filed: Aug. 29, 2016

(30) Foreign Application Priority Data
Sep. 24, 2015 (JP) 2015-187189

(51) Int. Cl. H04N 1/23

(52) U.S. Cl. CPC H04N 1/2323; H04N 1/2392; H04N 2201/0094

(57) ABSTRACT

An image formation section that forms an image on a transfer medium, a memory section that records transfer medium information on the transfer medium, and a control section that controls an image formation apparatus are provided, and the control section has a memorandum function of recording at least setting information relating to the transfer medium in the form of a memorandum in the memory section. The content of the memorandum is memorized as part of the transfer medium information or in relation to the transfer medium information.

The present U. S. patent application claims a priority under the Paris Convention of Japanese patent application No. 2015-187189 filed on Sep. 24, 2015, the entirety of which is incorporated herein by references.

### BACKGROUND OF THE INVENTION

Field of the Invention

The present invention relates to an image formation apparatus capable of use of a sheet profile, an image formation method capable of the same, and a non-transitory computer readable recording medium that stores an image formation program capable of the same.

Description of the Related Art

In an image formation apparatus, sheet type information is registered in information on setting of a sheet feed tray that feeds sheets, and an image is printed on a sheet of a predetermined sheet type fed from the sheet feed tray according to the printing conditions in image formation.

In related art, to set the sheet type information in the sheet feed tray setting information, frequently used sheet type information is registered as a sheet profile in advance, and the information is extracted from the sheet profile and set. The sheet type information can thus be readily set.

On the other hand, an image formation apparatus requires mechanical adjustment before printing in some cases. For example, in a case where continuous printing sheet is used as the sheet, “winding adjustment” and “shaft control,” in which sheet tension is adjusted, “ionizer,” which removes static electricity, and other types of adjustment are required, and it is necessary to change the types of adjustment in accordance with the type of sheet, the environment in which the apparatus is installed, and other factors. Adjustment values in accordance with which the adjustments are made need to be managed on a sheet basis.

To this end, an operator needs to manage the adjustment values for each sheet on a “paper basis” and therefore needs to keep possessing a table, such as the table below.

For example, 140 types of sheets are assumed to be used at present, and it is therefore very hard to pick one up from the following table. The operator possibly mistakenly picks a wrong one up, and it is desired to improve work efficiency and lower the frequency of the operator's mistake.

TABLE 1

| | Wound | Shaft | |
|---|---|---|---|
| Sheet profile | amount | control | Ionizer |
| Photo glossy roll | Hi | non- | use |
| | | rotation | |
| Matte rolled paper | Lo | rotation | not use |
| Rolled paper for high-grade | | Hi | non-use |
| photo | | rotation | |
| Yupo roll (waterproof) | Lo | rotation | not use |
| Yupo tack(with grey tinting | Hi | non- | use |
| adhesive on the back) | | rotation | |
| Double-sided Yupo roll | Lo | rotation | not use |
| Yupo suction tac | Hi | non- | use |
| | | rotation | |
| Matte vinyl chloride roll | Lo | rotation | not use |
| with adhesive | | | |
| Back light film roll | Hi | non- | use |
| | | rotation | |
| PET film roll | Lo | rotation | not use |
| Glossy transparent label | Hi | nonuse- | |
| roll | | rotation | |
| Eastlon reef M-NF | Lo | rotation | not use |

For example, Japanese Patent Laid-Open No. 2015-36229 proposes that even in a case where a third party's finisher the performance of which is unknown is connected to an image formation apparatus, appropriate advance evaluation before printing starts allows sheet ejection to be suspended in response to error notification from the finisher and further allows the sheet having caused the error to be displayed, and registering the sheet as a non-feedable sheet in a sheet feeding evaluation table allows a message stating whether a usable sheet has been set to be displayed in a panel in advance for prevention of decrease in the work efficiency.

The mechanical adjustment values described above and other values can be readily grasped, for example, by registration of the values in a sheet profile. However, since the mechanical adjustment values and other values vary depending on the model of the image formation apparatus, firmware and other types of software for the registration need to be prepared on an image formation apparatus model basis, and this is a cumbersome task. Further, in a case where sheet profiles are put together for management, it is difficult to put sheet profiles having different setting items together and manage them. A method for readily registering the mechanical adjustment value and other values in relation to sheet information is therefore desired.

### SUMMARY OF THE INVENTION

The present invention has been made in view of the circumstances described above as the background, and an object of the present invention is to provide an image formation apparatus capable of easy registration of mechanical adjustment values and other values in relation to information on a transfer medium, an image formation method capable of the same, and a computer readable recording medium that stores an image formation program capable of the same.

To achieve at least one of the abovementioned objects, according to an aspect, an image formation apparatus reflecting one aspect of the present invention includes

an image formation section that forms an image on a transfer medium,

a memory section that records transfer medium information on the transfer medium, and

a control section that controls the image formation apparatus, and

the control section has a memorandum function of recording at least setting information relating to the transfer medium in the form of a memorandum in the memory section.

In the image formation apparatus according to the abovementioned aspect, it is preferable that the control section memorizes a content of the memorandum as part of the transfer medium information in the memory section.

In the image formation apparatus according to the abovementioned aspect, it is preferable that the control section memorizes a content of the memorandum in relation to the transfer medium information in the memory section.

In the image formation apparatus according to the abovementioned aspect, it is preferable that the control section displays a content of the memorandum in a display area different from a display area where the transfer medium information other than the content of the memorandum is displayed.

In the image formation apparatus according to the abovementioned aspect, it is preferable that the control section is capable of setting enabling or disabling of a function of displaying a content of the memorandum.

In the image formation apparatus according to the abovementioned aspect, it is preferable that the setting information recorded in the form of the memorandum is a mechanical adjustment value of the image formation apparatus.

In the image formation apparatus according to the abovementioned aspect, it is preferable that the control section is unable to control mechanical adjustment based on the mechanical adjustment value.

In the image formation apparatus according to the abovementioned aspect, it is preferable that the setting information recorded in the form of the memorandum is defined as a first mechanical adjustment value, a second mechanical adjustment value is contained in the transfer medium information other than a content of the memorandum, and mechanical adjustment relating to the second mechanical adjustment value is controllable by the control section.

In the image formation apparatus according to the abovementioned aspect, it is preferable that the control section displays the setting information and an illustration that describes a content of the setting information in a display area different from a display area where the transfer medium information other than a content of the memorandum is displayed.

In the image formation apparatus according to the abovementioned aspect, it is preferable that the control section allows input to the displayed setting information.

In the image formation apparatus according to the abovementioned aspect, it is preferable that, when the transfer medium information is read from the memory section, the control section allows display of the setting information in the form of the memorandum and input of a memorandum.

In the image formation apparatus according to the abovementioned aspect, it is preferable that, when image formation on the transfer medium starts, and when the content of a memorandum is displayed, the control section closes a display screen in which the content of the memorandum is displayed.

In the image formation apparatus according to the abovementioned aspect, it is preferable that the control section does not compare the setting information with an actual setting value for confirmation.

To achieve at least one of the abovementioned objects, according to an aspect, an image formation method reflecting one aspect of the present invention is an image formation method for forming an image on a transfer medium, the method including

recording transfer medium information on the transfer medium, and

recording at least setting information relating to the transfer medium in a form of a memorandum.

To achieve at least one of the abovementioned objects, according to an aspect, a non-transitory computer readable recording medium that stores an image formation program reflecting one aspect of the present invention is a non-transitory computer readable recording medium that stores an image formation program executed by a control section that controls an image formation apparatus, the image formation program including

a transfer medium information memorizing step of recording transfer medium information on a transfer medium in a memory section, and

a memorandum memorizing step of recording at least setting information relating to the transfer medium in a form of a memorandum in the memory section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 shows a mechanical overview of an image formation apparatus according to an embodiment of the present invention;

FIG. 2 describes the structure of a sheet feed adjuster and mechanical adjustment in the sheet feed adjuster in the embodiment of the present invention;

FIG. 3 is an electrical block diagram of the image formation apparatus in the embodiment of the present invention;

FIG. 4 describes the structure of a sheet profile database and how to save the database in the embodiment of the present invention;

FIG. 5 is a flowchart for describing the procedure of extracting and registering a sheet profile in the embodiment of the present invention;

FIG. 6 is a flowchart for describing the procedure of extracting and displaying a sheet profile in the embodiment of the present invention;

FIG. 7 describes examples of a screen in which a sheet profile is extracted and displayed in the embodiment of the present invention;

FIG. 8 describes an example of a screen in which a memorandum of a sheet profile is displayed in the embodiment of the present invention;

FIG. 9 describes another example of the screen in which a memorandum of a sheet profile is extracted and displayed in the embodiment of the present invention;

FIG. 10 describes an example of a screen in which a memorandum of a sheet profile is extracted; and

FIG. 11 describes an example of a screen in which the content of the memorandum of the sheet profile is displayed and an example of a screen in which the content is set.

### DETAILED DESCRIPTION OF THE PREFERRED EMBODIMENTS

Hereinafter, an embodiment of the present invention will be described with reference to the drawings. However, the scope of the invention is not limited to the illustrated examples.

An embodiment of the present invention will be described below with reference to the accompanying drawings.

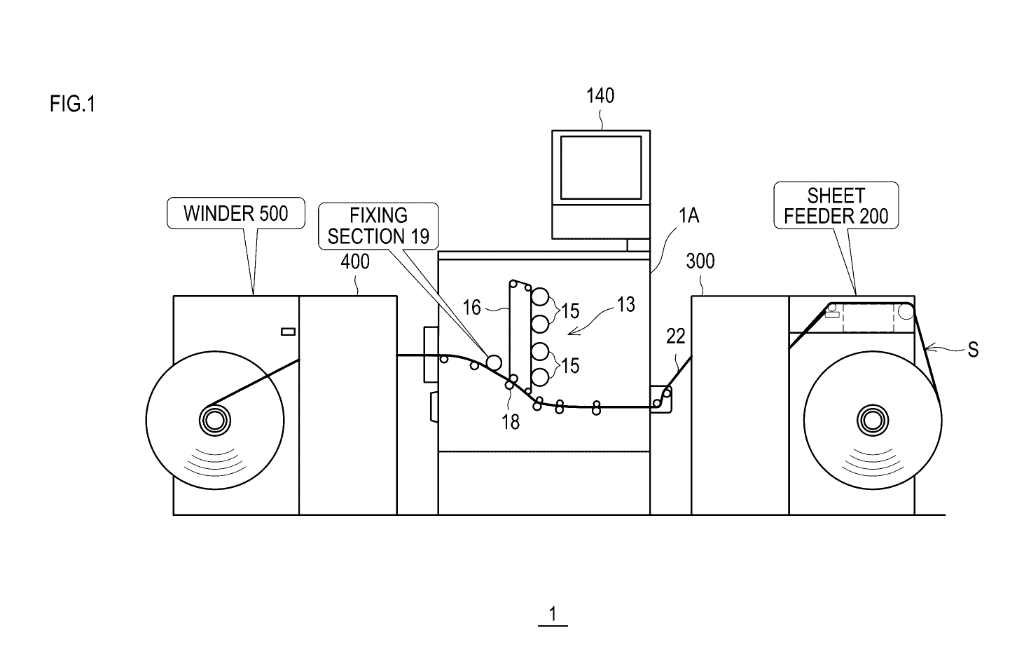

FIG. 1 shows a mechanical overview of an image formation apparatus according to the embodiment.

An image formation apparatus 1 includes an apparatus main body 1A having an image formation section 13, with a sheet feed adjuster 300 connected to the upstream side of the apparatus main body 1A and a sheet feeder 200 connected to the upstream side of the sheet feed adjuster 300. Further, a sheet ejection adjuster 400 is connected to the sheet ejection side of the apparatus main body 1A, and a winder 500 is connected to the sheet ejection side of the sheet ejection adjuster 400.

The embodiment is described on the assumption that the apparatus main body 1A and the sections connected to the apparatus main body 1A form the image formation apparatus 1, but the types and the numbers of sections connected to the apparatus main body 1A are not limited to specific types or numbers, and only the apparatus main body 1A can form the image formation apparatus. In this case, the apparatus main body 1A can form, along with other sections, an image formation system.

The sheet feeder 200 has a function of accommodating, holding, and feeding a roll of sheet S as a continuous sheet.

The sheet feed adjuster 300 has a buffer function of absorbing a small difference in speed and a small shift between the sheet feeder 200 and the apparatus main body 1A. The sheet ejection adjuster 400 has a buffer function of absorbing a small difference in speed and a small shift between the apparatus main body 1A and the winder 500. A cutter that cuts the roll of sheet can be installed between the apparatus main body 1A and the winder 500, and the cutter can perform the cutting in an offline process. The winder 500 has a function of winding the ejected roll of sheet and holding the wound roll of sheet.

In the embodiment, a roll of sheet is used as the continuous sheet, but the continuous sheet is not limited to a roll of sheet and only needs to be a sheet in a continuous form. For example, the continuous sheet includes a continuous slip sheet and a continuous business sheet. The continuous sheet can be provided in the form of a roll of sheet or can instead be provided in the form of an alternately folded stack of paper. The continuous sheet corresponds to a continuous transfer medium in the present invention. It is not necessarily essential that the continuous transfer medium is made of paper.

Further, the image formation apparatus according to the present invention can handle discrete sheets instead of a continuous sheet.

The continuous sheet and the discrete sheets described above correspond to the transfer medium in the present invention, but the material of the transfer medium in the present invention is not limited to paper.

The image formation apparatus 1 has the image formation section 13, which forms an image on a sheet, in the apparatus main body 1A, and further has an operation section 140, which accepts an operator's operation and displays information, in an upper portion of the apparatus main body 1A. The operation section 140 can be formed of two separate sections, an operation section operated by the operator and a display section that displays information. The operation section and the display section can instead be integrated with each other to form, for example, a touch panel LCD.

The image formation apparatus 1 has a transport path 22 starting from the sheet feeder 200 via the sheet feed adjuster 300 and reaching the image formation section 13 and further starting from the image formation section 13 via the sheet ejection adjuster 400 and reaching the winder 500.

The roll of sheet S accommodated in the sheet feeder 200 is fed along the transport path 22.

In the embodiment, the transport path 22, a transport roller, a motor that is not shown but drives a roller so driven as to rotate, and other components form a transport section.

The image formation section 13 has a photosensitive bodies 15 provided for multiple colors (such as cyan, magenta, yellow, and black), and a charger, a writer, and a development unit that are not shown are disposed in the space around each of the photosensitive bodies. The surface of each of the photosensitive bodies charged with the charger is exposed to image light produced by the writer, such as an LD, on the basis of information on an image of a document recorded in an image memory or any other memory device. A latent image is thus formed on the surface of each of the photosensitive bodies 15. The latent image is developed by the development unit into a toner image. The toner image is transferred to an intermediate transfer belt 16, and the images on the intermediate transfer belt 16 are transferred via a secondary transfer roller 18 onto the roll of sheet S transported along the transport path 22. The present invention has been described with reference to a color image formation apparatus having photosensitive bodies for multiple colors and the intermediate transfer belt, but the image formation apparatus according to the present invention can instead be formed of a black-and-white image formation apparatus.

The image transferred in the image formation section 13 is heated and pressurized by a fixing section 19, and the resultant fixed image is ejected out of the apparatus main body 1A as the roll of sheet is transported.

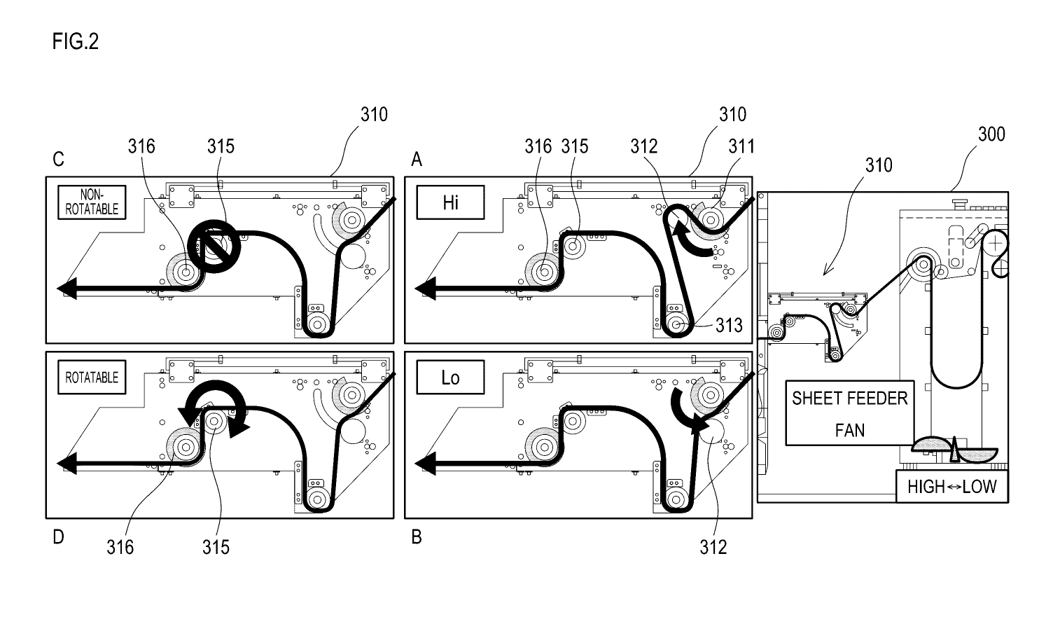

FIG. 2 are enlarged views (FIGS. 2A to 2D) each showing a mechanical internal structure of the sheet feed adjuster 300 and examples of adjustment and change.

The sheet feed adjuster 300 has an adjustment mechanism 310 and is capable of mechanical adjustment. The adjustment mechanism 310 has a rotary transport roller 311, which is located on the sheet introduction side and along which a sheet is caused to run, and a movable rotary roller 312, which is adjacent to the rotary transport roller 311, and the sheet is caused to run between the two rollers. An intermediate roller 313 is disposed in a position downstream of the rollers, and a rotation adjustment roller 315 and a rotary roller 316 are disposed in this order in further downstream positions. A configuration in which the continuous sheet is ejected is thus formed in the rear stage of the adjustment mechanism 310. The adjustment mechanism 310 can further include a transport member, such as another roller.

The movable rotary roller 312 is movable upward and downward along an arcuate path, and changing the position where the movable rotary roller 312 is set allows change in the amount of wound continuous sheet caused to run between the rotary transport roller 311 and the movable rotary roller 312.

In FIG. 2A, the movable rotary roller 312 is set in a high position (Hi), where a long wound length is achieved. In FIG. 2B, the movable rotary roller 312 is set in a low position (Lo), where a short wound length is achieved.

In this example, the position of the movable rotary roller 312 can be changed between the two discrete positions. However, the number of positions is not limited to a specific value, and the position can instead be changed continuously.

The sheet is caused to run between the rotation adjustment roller 315 and the rotary roller 316, and the state of the rotation adjustment roller 315 is switchable between rotatable and non-rotatable. The switching allows adjustment of tension acting on the sheet.

In FIG. 2C, the state of the rotation adjustment roller 315 is set to be non-rotatable, which increases the tension acting on the sheet between the rotation adjustment roller 315 and the rotary roller 316. In FIG. 2D, the state of the rotation adjustment roller 315 is set to be rotatable, which decreases the tension acting on the sheet between the rotation adjustment roller 315 and the rotary roller 316.

The rotation adjustment roller 315 can be configured to further allow torque produced when it rotates to be changed stepwise or continuously in addition to the switching between the rotatable state and the non-rotatable state.

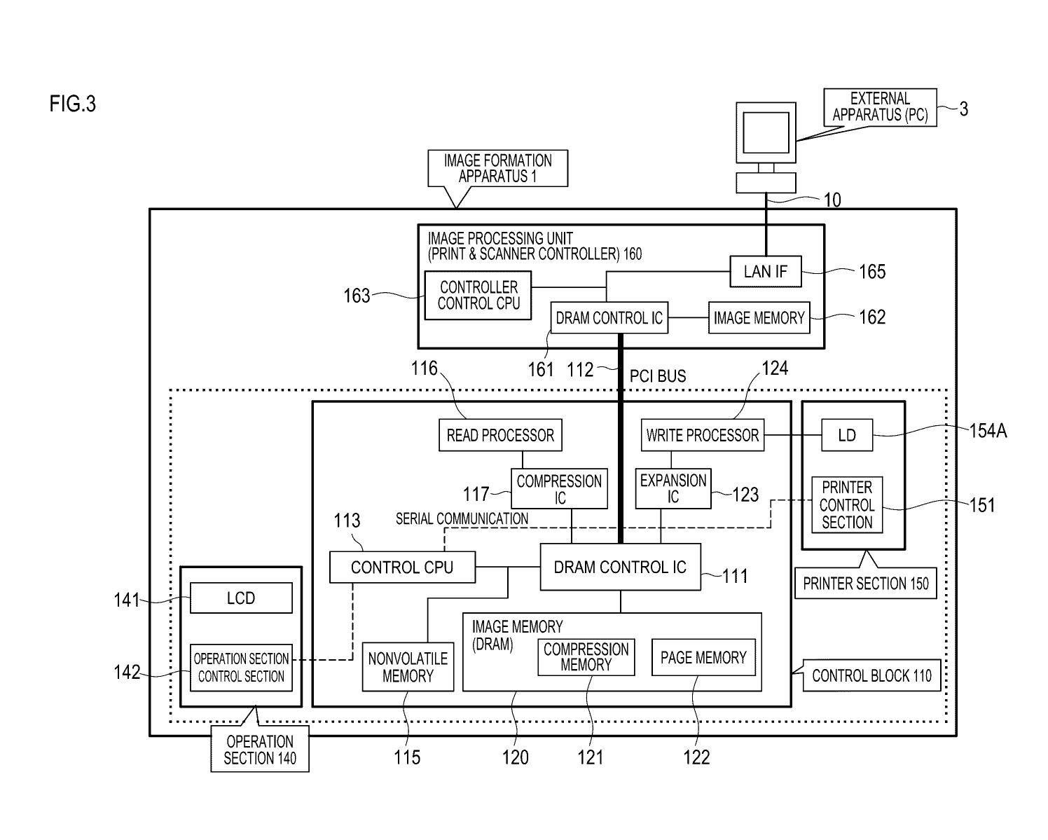

The image formation apparatus 1 will next be functionally described with reference to the block diagram of FIG. 3.

The image formation apparatus 1 includes, as a primary configuration thereof, a copier main body having a control block 110, the operation section 140, and a printer section 150 and an image processing unit (print & scanner controller) 160, which processes image data inputted from and outputted to an external apparatus (PC) 3 over a network 10.

The control block 110 has a PCI bus 112, and the PCI bus 112 is connected to a DRAM control IC 111 in the control block 110.

The control block 110 further includes a control CPU 113, and the DRAM control IC 111 is connected to the control CPU 113. A nonvolatile memory 115 is further connected to the control CPU 113. The nonvolatile memory 115 stores a program that allows the control CPU 113 to operate, data for setting the image formation apparatus 1, process control parameters, tray settings, sheet profiles, and other pieces of information. The nonvolatile memory that stores the sheet profiles corresponds to the memory section in the present invention. The sheet profiles can instead be stored in another memory section provided in the image formation apparatus or can still instead be stored in an external memory device connected to the apparatus main body 1A or a memory device attachable to and detachable from the apparatus main body 1A.

The control CPU 113 controls the entire image formation apparatus 1 and grasps the state of the entire image formation apparatus, specifically, performs rolled sheet transport control, image formation control, and other types of control. That is, the control CPU 113 functions as the control section in the present invention.

An image formation program that allows the control CPU 113 to operate is stored on a computer readable recording medium, and the nonvolatile memory 115 corresponds to the memory medium in the present invention. The image formation program can instead be a program stored in a mobile memory medium and distributed in the form of the mobile memory medium. In a case where the image formation apparatus includes an HDD or an SSD, the image formation program can be stored in the HDD or the SSD. In this case, the HDD or the SSD corresponds to the memory medium in the present invention.

The image data, which is read, for example, with a scanner, is processed by a read processor 116. The read processor 116 is connected to a compression IC 117, which compresses the image data in a predetermined method. The compression IC 117 is connected to the DRAM control IC 111.

The operation section 140 described above includes a touch-panel-type LCD 141 and an operation section control section 142. The LCD 141 and the operation section control section 142 are connected to each other, and the operation section control section 142 is so connected to the control CPU 113 that they can communicate with each other in serial communication. The configuration described above allows the control CPU 113 to control the operation section 140. The operation section control section 142 can be formed of a CPU, a program that allows the CPU to operate, and other components.

The operation section 140 is used to perform setting of the apparatus main body 1A, the sheet feeder 200, the sheet feed adjuster 300, and the sheet ejection adjuster 400 and controls image formation and sheet feeding from the sheet feeder 200 to the winder 500 on the basis of the settings.

The operation section 140 allows settings in the image formation apparatus 1 and input of action control conditions, such as action instructions, and further allows the contents of the settings, the state of the machine, and information on the machine to be displayed or otherwise handled, and the operation section 140 is controlled by the control CPU 113. The operation section 140 allows predetermined and other types of operation. For example, the operation section 140 allows mechanical adjustment values to be recorded by use of a memorandum function and stored in a recording section.

The DRAM control IC 111 is connected to an image memory 120 formed of a compression memory 121 and a page memory 122. The image memory 120 stores image data acquired with a scanner and image data acquired over the network.

The image memory 120 is an area where the image data is memorized and stores image data on a job to be printed. The DRAM control IC 111 allows the image memory 120 to memorize image data on a plurality of jobs.

The compression IC 117, which compresses the image data, and an expansion IC 123, which expands the compressed data, are connected to the DRAM control IC 111. A write processor 124 is connected to the expansion IC 123. The write processor 124 is connected to an LD 154A in the printer section 150 and processes data used to cause the LD 154A operate. The LD 154A collectively refers to LDs for multiple colors. The printer section 150 controls the transport section, which includes the image formation section 13 and the transport path 22.

The printer section 150 includes a printer control section 151, which controls the entire printer section 150, and the printer control section 151 is connected to the control CPU 113 described above and controlled by the control CPU 113. That is, printing action is initiated and terminated in accordance with parameters given by the control CPU 113. The sheet feeder 200 and the winder 500 are so connected to the printer control section 151 as to be controllable by the printer control section 151, and the control CPU 113 can issue control instructions via the printer control section 151 to feed and wind the roll of sheet.

A DRAM control IC 161 in the image processing unit (print & scanner controller) 160 described above is connected to the PCI bus 112, which is connected to the DRAM control IC 111 described above. In the image processing unit (print & scanner controller) 160, an image memory 162 is connected to the DRAM control IC 161. Further, in the image processing unit (print & scanner controller) 160, a controller control CPU 163 is connected to the DRAM control IC 161, and a LAN interface 165 is connected to the DRAM control IC 161. The LAN interface 165 is connected to the network 10.

The external apparatus (PC) 3 and other components are connected to the network 10, whereby image data can be transmitted to and received from the image formation apparatus 1.

Basis action of the image formation apparatus 1 will next be described.

The procedure of accumulating image data in the image formation apparatus 1 will first be described.

In a case where an image of a document is read with a scanner to produce image data, the scanner optically reads an image of the document. The read processor 116 causes the read image to undergo data processing, and the compression IC 117 compresses the image data having undergone the data processing by using a predetermined method and stores the compressed image data in the compression memory 121 via the DRAM control IC 111. The image data stored in the compression memory 121 can be managed as a job by the control CPU 113.

In a case where image data is externally acquired, for example, image data transmitted from the external apparatus (PC) 3 over the network 10 is stored in the image memory 162 via the LAN interface 165 by the DRAM control IC 161, which is controlled by the controller control CPU 163. The data in the image memory 162 is temporarily stored in the page memory 122 via the DRAM control IC 161, the PCI bus 112, and the DRAM control IC 111. The data stored in the page memory 122 is successively sent to the compression IC 117 via the DRAM control IC 111, compressed, stored in the compression memory 121 via the DRAM control IC 111, and managed by the control CPU 113 in the same manner described above.

In a case where the image formation apparatus 1 outputs an image, that is, in a case where the image formation apparatus 1 is used as a copier or a printer, the image data stored in the compression memory 121 is sent to the expansion IC 123 via the DRAM control IC 111, where the compressed image data is expanded, and the expanded image data is repeatedly expanded by the write processor 124 in the LD 154A, whereby the image data can be printed on the roll of sheet S.

In the case where the image formation apparatus 1 is used as a copier, print conditions (print mode) and other pieces of information set via the operation section 140 are notified, and the control CPU 113 creates setting information. The created setting information can be stored in a RAM in the control CPU 113.

In the case where the image formation apparatus 1 is used as a printer, the printing conditions are set by a printer driver in the external apparatus (PC) 3. The thus set printing conditions are sent via the external apparatus (PC) 3, the LAN IF 165, the image memory 162, the DRAM control IC 161 (controller), and the DRAM control IC 111 (main body) and stored in the page memory 122, in the same manner in which an image is sent and stored.

In the printer section 150, the printer control section 151 having received an instruction from the control CPU 113 controls each section of the printer section 150.

In the case where the image formation apparatus 1 outputs an image, the printing conditions can be set via the operation section 140, and the control CPU 113 can control the printing in accordance with the setting. The printing conditions can include a sheet feed tray setting in which a sheet profile is set.

In the image formation section 13, after a toner image written on each of the photosensitive bodies 15 is transferred onto the intermediate transfer belt 16, the toner images are transferred by the secondary transfer roller 18 onto the roll of sheet S supplied by the sheet feeder 200 and fixed by the fixing section 19. The sheet on which an image has been formed is transported along the transport path 22 to the sheet ejection adjuster 400 and wound by the winder 500, which is located on the downstream side, into a roll, and the roll is held in winder 500.

The above description has been made with reference to a case where the control CPU 113 controls extraction of a sheet profile, display of a memorandum of the sheet profile, registration of the sheet profile, and other types of action. Instead, a control section provided in a management apparatus connected to the image formation apparatus over a network can control the image formation apparatus, and the control section in the management apparatus can control the display and registration of a memorandum of a sheet profile described above and other types of action. An image formation method and an image formation program in the latter case fall within the scope of the present invention.

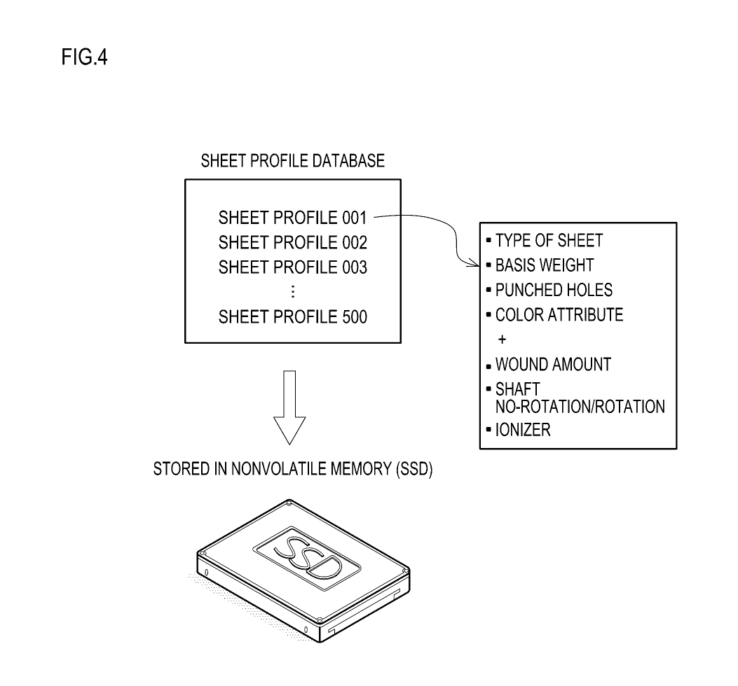

A sheet profile database will next be described with reference to a conceptual view of FIG. 4.

The sheet profile database, which allows registration of a plurality of sheet profiles, is stored, for example, in the nonvolatile memory 115. FIG. 4 shows an example in which sheet profile data are stored in a nonvolatile memory (SSD: solid-state drive).

A sheet profile contains the type of sheet, basis weight, punched holes, color attribute, and other characteristics and further contains the contents of settings of the wound amount, shaft no-rotation/rotation, and ionizer in the form of memorandum. The type of sheet, basis weight, punched holes, color attribute, and other characteristics are items set as items contained in a sheet profile in related art, and in this example, the memorandum (such as the wound amount) is added to the items to create a sheet profile.

The type of sheet, basis weight, punched holes, color attribute, and other characteristics are items controllable by the control section, and a variety of types of control are performed on the apparatus on the basis of the contents of the settings. For example, a sheet feed tray is selected on the basis of the type of sheet, the basis weight, and other factors. Further, for example, punching is controlled on the basis of the punched hole setting, and image formation is controlled on the basis of the color attribute. The contents of the settings can be set by a user via the operation section 140 or can be first set at default values and then changed.

Among the contents of the settings described above, the wound amount, shaft no-rotation/rotation, and ionizer are recorded by use of the memorandum function and correspond to the mechanical adjustment values. The control section can only display the contents but cannot control the apparatus on the basis of the contents of the settings. Further, the control section cannot compare the contents of the settings in the form of a memorandum with the contents of actual settings for confirmation purposes.

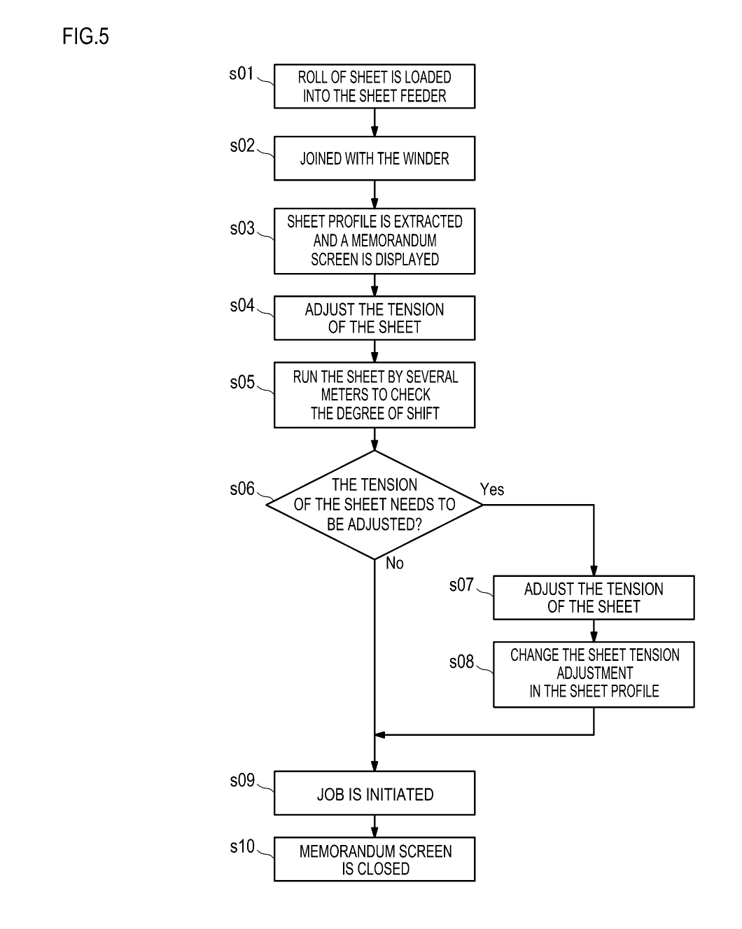

The contents of the steps using the sheet profile described above will next be described with reference to the flowchart of FIG. 5.

A roll of sheet is first loaded into the sheet feeder 200 (feeder) (step s01) and joined with the winder (step s02). A sheet profile is then extracted, and a memorandum screen is displayed (step s03). The displayed memorandum screen shows a part of the content in the present embodiment. The display of the memorandum screen is performed under the control of the control section.

The user then adjusts the tension of the sheet (step s04). The user can run the sheet by several meters to check the degree of shift thereof (step s05).

The user further evaluates whether the tension of the sheet needs to be adjusted (step s06). When no adjustment of the tension of the sheet is necessary (No in step s06), a job is initiated (step s09). On the other hand, when adjustment of the tension of the sheet is necessary (Yes in step s06), the user adjusts the tension of the sheet (step s07) and records the content of the setting of the sheet tension adjustment in the sheet profile by using the memorandum function (step s08). Realization of the memorandum function is achieved by the embodiment of the present invention. After the recording, the recording section stores the sheet profile.

A job is then initiated (step s09). After the job is initiated, the memorandum screen is closed (step s10). The control section does not receive any instruction from the user but performs the procedure of closing the memorandum screen when the job is initiated.

Since the fact that a print job is carried out means that the adjustment has been completed, automatically closing the memorandum screen stops keeping the contents of the memorandum displayed, whereby necessary information, such as display of the print job and print materials, can be displayed. Further, no operation of causing the memorandum screen to transition to another is required.

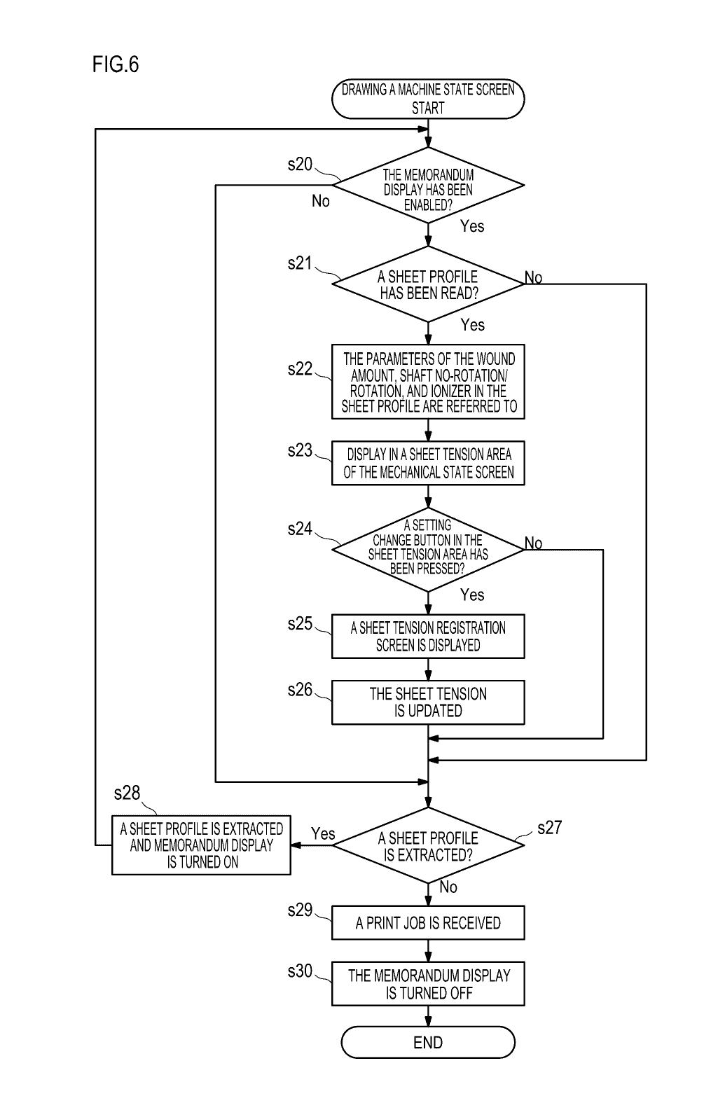

The procedure of extracting and displaying a sheet profile will next be described with reference to the flowchart of FIG. 6. The following procedure is performed under the control of the control section.

It is assumed in the image formation apparatus that the function of displaying a memorandum of a sheet profile can be enabled and disabled.

When the image formation apparatus starts drawing a machine state setting screen, it is evaluated whether the memorandum display has been enabled (step s20). The memorandum display is so set in advance as to be ON or OFF, and the setting is stored, for example, in the nonvolatile memory 115.

When the memorandum display has not been set ON (No in step s20), it is evaluated whether a sheet profile is extracted (step s27). When the memorandum display has been set ON (Yes in step s20), it is evaluated whether a sheet profile has been read (step s21). Sheet profiles are stored, for example, in the nonvolatile memory. When no sheet profile has been read (No in step S21), it is evaluated in step s27 whether a sheet profile is extracted.

When a sheet profile has been read (Yes in step s21), the parameters of the wound amount, shaft no-rotation/rotation, and ionizer in the sheet profile are referred to (step s22). The parameters are displayed in a sheet tension area of the mechanical state screen (step s23). The parameters are displayed in a display area separate from a display area where the controllable parameters in the sheet profile are displayed.

According to the procedure described above, the operator does not need to intentionally extract the memorandum screen, preferably resulting in a decrease in the cumbersomeness of the operation. The automatic display of the parameters also serves as a warning that prompts the operator to make mechanical adjustment, preferably resulting in elimination of the operator's mistake (preventing operator from forgetting adjustment).

It is then evaluated whether a setting change button in the sheet tension area has been pressed (step s24). When the sheet tension setting change button has not been pressed (No in step s24), it is evaluated in step s27 whether a sheet profile is extracted.

When the sheet tension setting change button has been pressed (Yes in step s24), a sheet tension registration screen is displayed (step s25), and the operator's operation of changing the sheet tension is accepted and registered (updated) (step s26), followed by evaluation of whether a sheet profile is extracted in step s27.

When a sheet profile is extracted (Yes in step s27), a sheet profile is extracted and memorandum display is turned on (step s28), followed by transition to step s20.

When no sheet profile is extracted (No in step s27), a print job is received (step s29), and the memorandum display is turned off (step s30), followed by termination of the process. Whether a sheet profile is extracted can be determined by the user or can be set in advance in accordance with the setting of the machine.

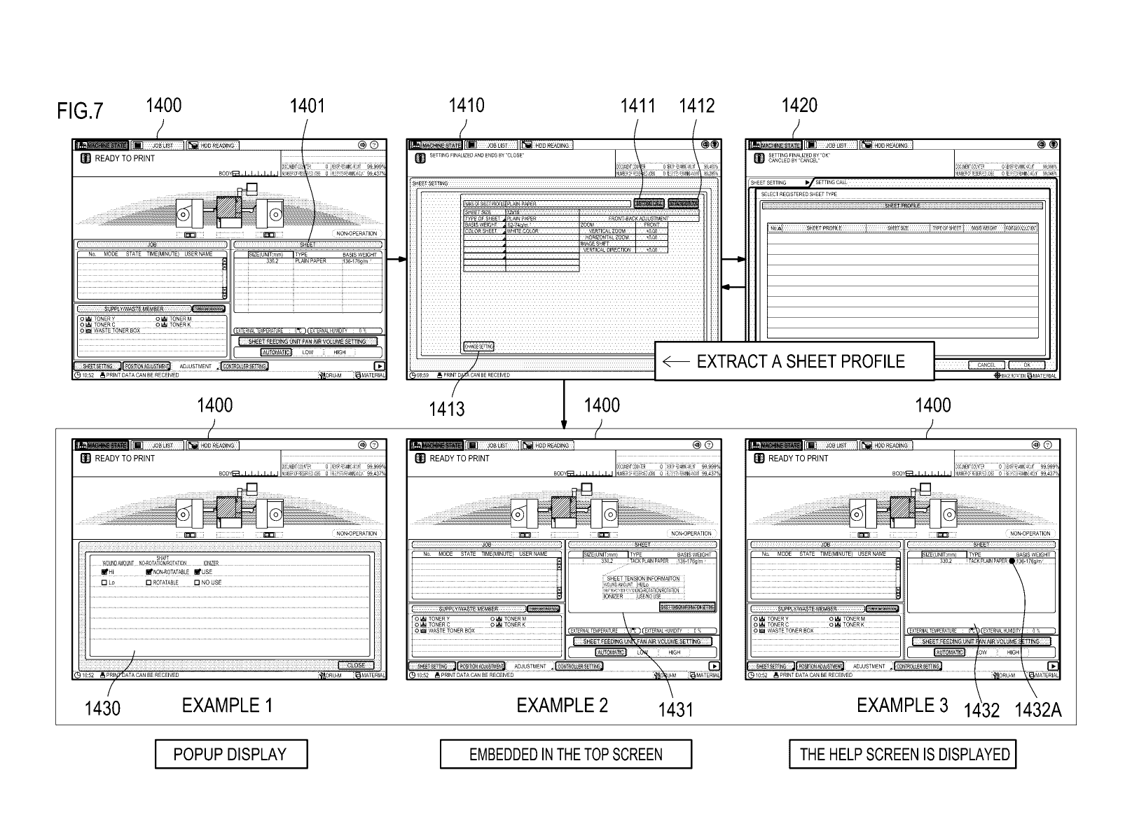

FIG. 7 shows an example of screens before the sheet profile screen is invoked.

In a mechanical state screen 1400 (upper left screen in FIG. 7) displayed in the operation section 140, a sheet field 1401 is displayed. When the sheet field 1401 is pressed, a sheet setting screen 1410 is displayed. In the sheet setting screen 1410, an extraction button 1411 and a setting registration button 1412 are so displayed that they can be pressed. When the extraction button 1411 is pressed, a sheet type list screen 1420 is displayed. The sheet type list can be a list in which mechanical adjustment values controllable by the control section are set. The mechanical adjustment values correspond to a second mechanical adjustment value in the present invention. When a desired sheet type is selected in the sheet type list screen 1420, the contents of the selected sheet type are extracted and reflected in the sheet setting screen 1410. The contents in the sheet setting screen 1410 are registered as a sheet profile, for example, in the nonvolatile memory when the setting registration button 1412 is pressed.

In the sheet setting screen 1410, a setting change button 1413 is further so displayed that it can be pressed.

When the setting change button 1413 is pressed, the display screen transitions to a screen where a memorandum can be displayed. The contents of a memorandum are displayed in a display area different from the sheet setting screen where the controllable parameters in the sheet profile are displayed. In the embodiment, three display examples are shown.

In the lower left example in FIG. 7, a memorandum setting display screen 1430, in which the content of a memorandum is displayed, is displayed in the form of a popup in the machine state screen 1400, which is the top screen. The memorandum setting display screen 1430 allows wound amount selection, Hi or Lo, shaft no-rotation/rotation selection, no-rotation or rotation, and ionizer selection, “use ionizer” or “use no ionizer,” and further allows display of results of the selection.

In the lower central example in FIG. 7, a sheet field 1431 is displayed in the machine state screen 1400, which is the top screen, and allows the memorandum screen to be invoked.

In the lower right example in FIG. 7, a sheet field 1432 is displayed in the machine state screen 1400, which is the top screen, and a help button 1432A, which invokes the memorandum screen, is displayed in the sheet field 1432.

Displaying the memorandum screen and the sheet profile screen, which differs from the memorandum screen, in different display areas allows the operator to view the contents of the two screens in the way in which they are clearly separate from each other, whereby mechanical adjustment values in the memorandum screen will not be taken as setting values.

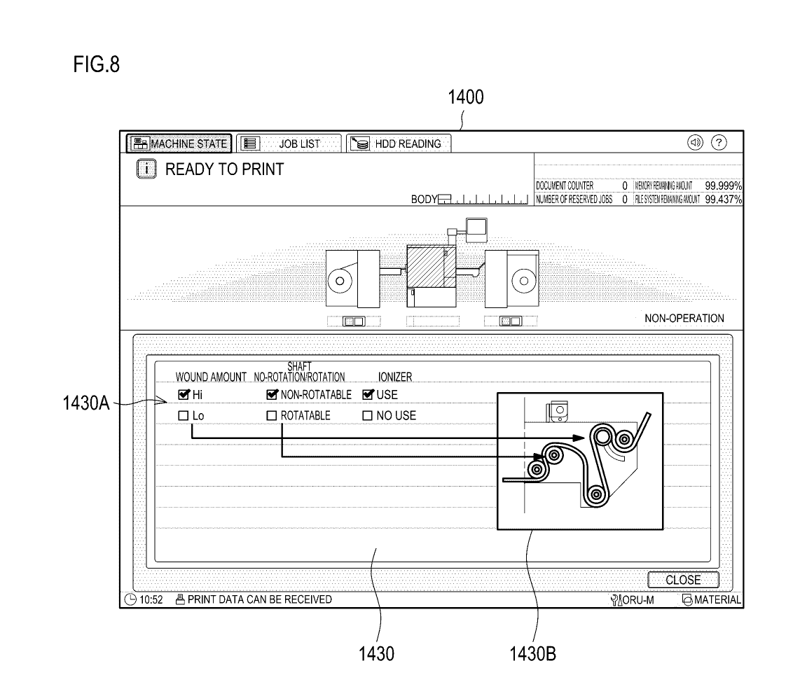

FIG. 8 is an example of a screen showing an example in which the memorandum screen is displayed in the form of a popup.

The memorandum setting display screen 1430 is displayed in the form of a popup in the machine state screen 1400.

In the memorandum setting display screen 1430, a mechanical adjustment checkbox 1430A is provided for each of the wound amount, the shaft no-rotation/rotation, and the ionizer. In the wound amount checkbox, “Hi” or “Lo” is selectable. In the shaft no-rotation/rotation checkbox, “no-rotation” or “rotation” is selectable. In the ionizer checkbox, “use ionizer” or “use no ionizer” is selectable. A set content is labeled with a checkmark and therefore clearly shown. The set contents correspond to a first mechanical adjustment value.

An illustration 1430B, which illustrates setting items, is shown in a right portion of the memorandum setting display screen 1430 and allows the operator to readily grasp the position of each of the items.

Displaying adjustment values paired with an illustration allows the operator to intuitively identify target portions and eliminates adjustment mistakes, preferably resulting in reduction in waste paper.

The memorandum setting display screen 1430 displayed in the form of a popup is closed when a print job is received.

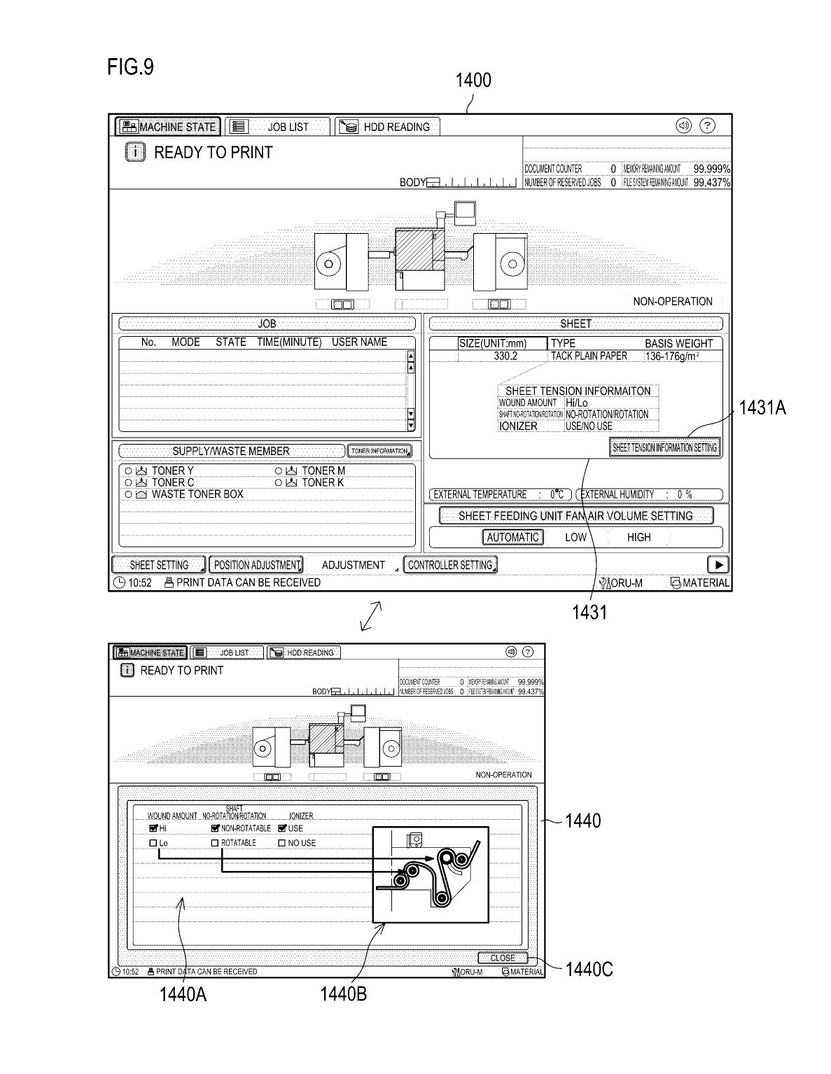

FIG. 9 is an example in which the memorandum screen is embedded in the top screen.

In this example, the sheet field 1431 is displayed in the machine state screen 1400, and a sheet tension information setting button 1431A is so displayed in the sheet field 1431 that the button can be pressed.

When the sheet tension information setting button 1431A is pressed, a memorandum setting display screen 1440 is so displayed as to be embedded in the machine state screen 1400. In the memorandum setting display screen 1440, mechanical adjustment checkboxes 1440A and an illustration 1440B, which shows portions where mechanical adjustments are made, are displayed, as in the case of the memorandum setting display screen 1430. In the memorandum setting display screen 1440, a close button 1440C is so displayed that it can be pressed. When the close button 1440C is pressed, the screen transitions to the machine state screen 1400 in which the sheet field 1431 is displayed. The memorandum setting display screen 1440 is closed when a print job is received.

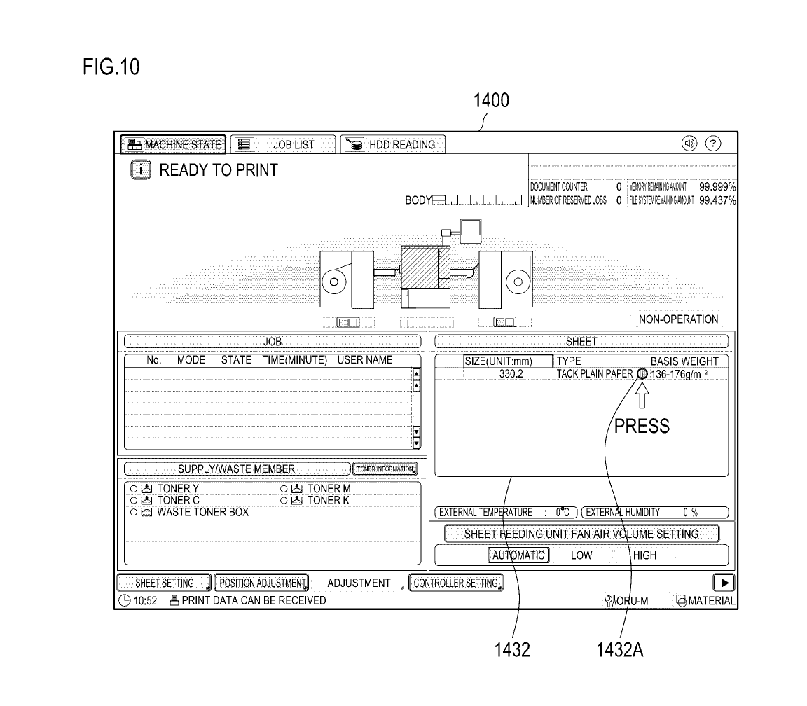

FIG. 10 is an example of a screen in which the memorandum screen is displayed by using a help function.

The sheet field 1432 is displayed in the machine state screen 1400, and a help button 1432A is so displayed in the sheet field 1432 that the button can be pressed.

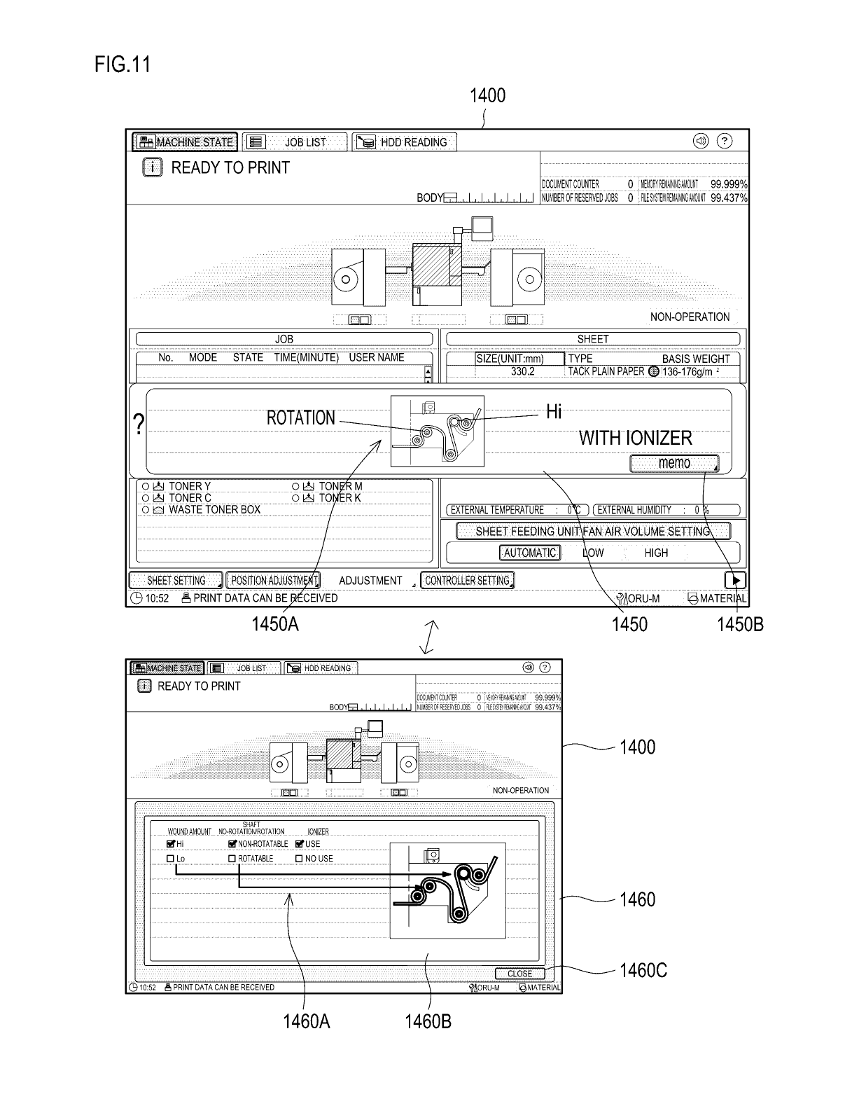

When the help button 1432A is pressed, a memorandum display screen 1450, which displays the content of a memorandum, is displayed in the machine state screen 1400, as shown in FIG. 11. In the memorandum display screen 1450, a setting content display 1450A, which displays mechanical adjustment values along with an illustration, is displayed. A “memo” button 1450B is so displayed in the memorandum display screen 1450 that the button can be pressed.

When the “memo” button 1450B is pressed, a memorandum setting display screen 1460 is displayed in the form of a popup. In the memorandum setting display screen 1460, mechanical adjustment checkboxes 1460A allow setting the mechanical adjustments, and an illustration 1460B for mechanical adjustments is displayed. In the memorandum setting display screen 1460, a close button 1460C is so displayed that it can be pressed. When the close button 1460C is pressed, the memorandum setting display screen 1460 is closed. Further, when any of the settings has been changed in the memorandum setting display screen 1460, the content of the change is stored, for example, in the nonvolatile memory.

The memorandum setting display screen 1460 is closed when a print job is received.

The above description has been made on the assumption that a sheet profile contains the content of a memorandum. Instead, a sheet profile and the content of a memorandum can be stored in the form of separate data sets but related to each other.

That is, according to the present embodiment, setting information relating to a transfer medium can be memorized in the form of a memorandum, whereby the setting information can be readily checked and the amount of operator's mistake is therefore reduced. Further, the setting can be readily performed, preferably resulting in improvement in productivity.

The present invention has been described on the basis of the embodiment described above, but the present invention is not limited to the contents of the embodiment described above. The scope of the embodiment described above can be changed as appropriate to the extent that the change does not depart from the scope of the present invention.

Although the present invention has been described and illustrated in detail, it is clearly understood that the same is by way of illustrated and example only and is not to be taken by way limitation, the scope of the present invention being interpreted by terms of the appended claims.

What is claimed is:

1. An image formation apparatus comprising:
an image formation section that forms an image on a transfer medium;
a memory section that records transfer medium information on the transfer medium; and
a control section that controls the image formation apparatus,
wherein the control section has a memorandum function of recording at least setting information relating to the transfer medium in the form of a memorandum in the memory section.

2. The image formation apparatus according to claim 1, wherein the control section memorizes a content of the memorandum as part of the transfer medium information in the memory section.

3. The image formation apparatus according to claim 1, wherein the control section memorizes a content of the memorandum in relation to the transfer medium information in the memory section.

4. The image formation apparatus according to claim 1, wherein the control section displays a content of the memorandum in a display area different from a display area where the transfer medium information other than the content of the memorandum is displayed.

5. The image formation apparatus according to claim 1, wherein the control section is capable of setting enabling or disabling of a function of displaying a content of the memorandum.

6. The image formation apparatus according to claim 1, wherein the setting information recorded in the form of the memorandum is a mechanical adjustment value of the image formation apparatus.

7. The image formation apparatus according to claim 6, wherein the control section is unable to control mechanical adjustment based on the mechanical adjustment value.

8. The image formation apparatus according to claim 6, wherein the setting information recorded in the form of the memorandum is defined as a first mechanical adjustment value, a second mechanical adjustment value is contained in the transfer medium information other than a content of the memorandum, and mechanical adjustment relating to the second mechanical adjustment value is controllable by the control section.

9. The image formation apparatus according to claim 1, wherein the control section displays the setting information and an illustration that describes a content of the setting information in a display area different from a display area where the transfer medium information other than a content of the memorandum is displayed.

10. The image formation apparatus according to claim 9, wherein the control section allows input to the displayed setting information.

11. The image formation apparatus according to claim 1, wherein when the transfer medium information is read from the memory section, the control section allows display of the setting information in the form of the memorandum and input of a memorandum.

12. The image formation apparatus according to claim 1, wherein when image formation on the transfer medium starts, and when the content of a memorandum is displayed, the control section closes a display screen in which the content of the memorandum is displayed.

13. The image formation apparatus according to claim 1, wherein the control section does not compare the setting information with an actual setting value for confirmation.

14. An image formation method for forming an image on a transfer medium, the method comprising:
recording transfer medium information on the transfer medium; and
recording at least setting information relating to the transfer medium in a form of a memorandum.

15. The image formation method according to claim 14, wherein a content of the memorandum is memorized as part of the transfer medium information or in relation to the transfer medium information.

16. The image formation method according to claim 14, wherein a content of the memorandum is displayed in a display area different from a display area where the transfer medium information other than the content of the memorandum is displayed.

17. A non-transitory computer readable recording medium that stores an image formation program executed by a control section that controls an image formation apparatus, the image formation program comprising:
a transfer medium information memorizing step of recording transfer medium information on a transfer medium in a memory section; and
a memorandum memorizing step of recording at least setting information relating to the transfer medium in a form of a memorandum in the memory section.

18. The non-transitory computer readable recording medium that stores an image formation program according to claim 17, wherein in the memorandum memorizing step, a content of the memorandum is memorized in the memory section as part of the transfer medium information or in relation to the transfer medium information.

19. The non-transitory computer readable recording medium that stores an image formation program according to claim 17, wherein the image formation program further comprises a display step of displaying a content of the memorandum in a display area different from a display area where the transfer medium information other than the content of the memorandum is displayed.
